(19) United States
(12) Patent Application Publication
(10) Pub. No.: US 2013/0017707 A1
(43) Pub. Date: Jan. 17, 2013

(54) CONNECTOR ASSEMBLY

(71) Applicants: JIAN-CHUN PAN, Shenzhen City (CN); HAI-QING ZHOU, Shenzhen City (CN); YI-XIN TU, Shenzhen City (CN)

(72) Inventors: JIAN-CHUN PAN, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/280,297

(22) Filed: Oct. 24, 2011

(30) Foreign Application Priority Data
Jul. 13, 2011 (CN) 201110195478.0

(51) Int. Cl. H01R 13/627

(52) U.S. Cl. 439/357

(57) ABSTRACT

A connector assembly includes a first connector and a second connector. The first connector includes a main body, and a latching member extending out from the main body. The latching member includes a resilient extending portion extending from an outer surface of the main body, and a latching protrusion extending out from the extending portion. The second connector to be connected to the first connector, and includes a base, and a connecting member extending out from an outer surface of the base. The connecting member defining sliding groove and a receiving portion communicating with the sliding groove for latching the latching protrusion. Wherein when the first and second connectors are being connected, the latching member slides through the sliding groove, such that the latching protrusion is latched in the receiving portion.

### BACKGROUND

1. Technical Field

The present disclosure relates to connector assemblies, and particularly, to a connector assembly for electrically connecting a hard disk drive to a motherboard.

2. Description of Related Art

Hard disk drives are necessary in most computers, and need a connector assembly to be electrically coupled to the motherboard. The connector assembly includes a female connector and a male connector. However, after a substantial number of connections and disconnections, the connection between the female connector and the male connector may no longer be firm, and the integrity of the electrical connection can be reduced, causing non-recognition and other errors in the hard disk drive.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a connector assembly.

FIG. 2 is an isometric view of the assembled connector assembly of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

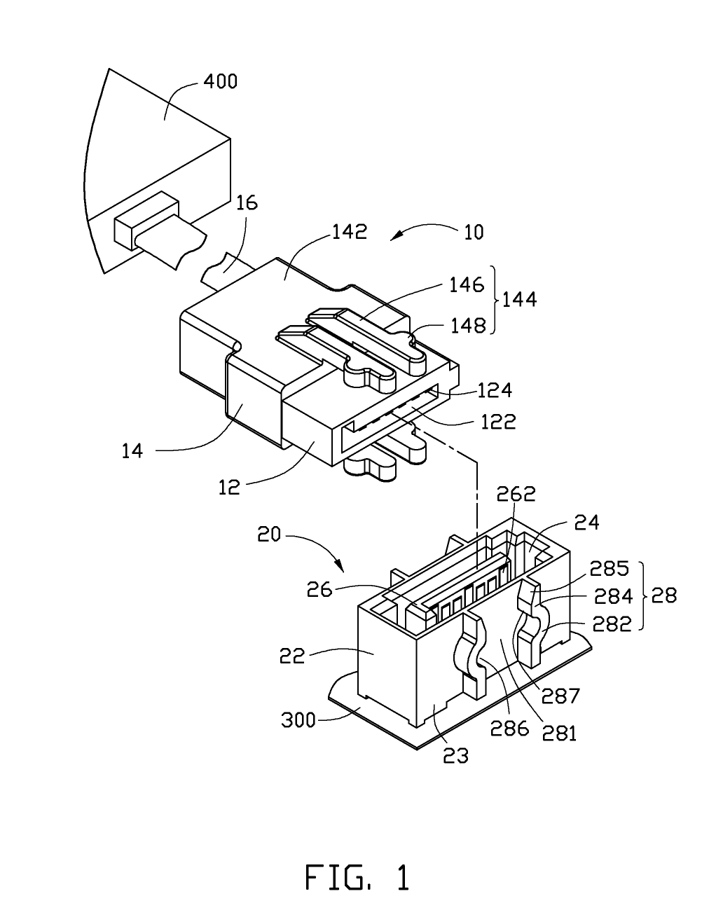

Referring to FIG. 1, an exemplary embodiment of a connector assembly includes a first connector 10 electrically coupled to a hard disk drive 400, and a second connector 20 arranged on a motherboard 300. In the embodiment, the first connector 10 is a serial advanced technology attachment (SATA) female connector, and the second connector 20 is a SATA male connector.

The first connector 10 includes an insulated main body 14, a rectangular inserting portion 12 extending out from a first end of the main body 14, and an electrical wire 16 connected between the second end of the main body 14 and the hard disk drive 400. The end surface of the inserting portion 12 opposite to the first main body 14 defines an inserting slot 122. A plurality of electrical terminals 124 is arranged on a sidewall of the inserting slot 122, electrically coupled to the electrical wires 16. The main body 14 includes two opposing side surfaces 142. A pair of spaced latching members 144 protrudes from each side surface 142, at the first end. Each latching member 144 includes a resilient extending portion 146 extending from the side surface 142 toward the inserting portion 12, and a semicircular latching protrusion 148 extending from the middle of the extending portion 146 away from the other extending portion 146. In the embodiment, the latching members 144, the main body 14, and the inserting portion 12 are integrally formed.

The second connector 20 is fixed on and electrically coupled to the motherboard 300. The second connector 20 includes an insulated base 22 with two opposing sidewalls 23. A pair of spaced connecting members 28 protrudes from one outer surface of each sidewall 23, and the connecting members 28 cooperatively bound a sliding groove 281. The base 22 defines a rectangular receiving slot 24 extending through the top end surface of the base 22. A tongue 26 extends up from the bottom of the receiving slot 24, with a plurality of electrical terminals 262 arranged on a side surface of the tongue 26 and electrically coupled to the motherboard 300.

Each connecting member 28 includes a humped receiving portion 282 protruding out from the sidewall 23, and a bar-shaped guiding portion 284 extending from the top of the receiving portion 282 to the end face of the second connector 20. An upper portion of the guiding portion 284 defines a ramped guiding surface 285 facing the other connecting member 28. The receiving portion 282 defines an opening 286 facing the other connecting member 28. The junction of the receiving portion 282 and the guiding portion 284 forms an arc-shaped guiding portion 287. In the embodiment, the connecting members 28 and the base 22 are integrally formed.

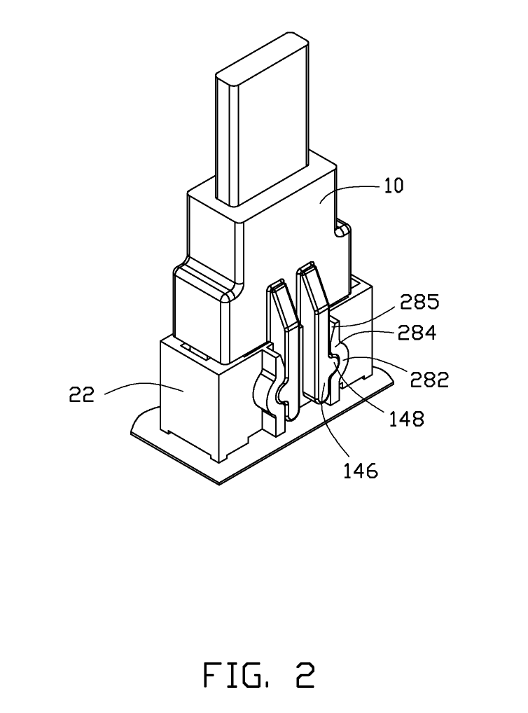

Referring to FIG. 2, illustrating the first connector 10 is inserted into the second connector 20. The inserting portion 12 is inserted into the receiving slot 24. The tongue 26 is inserted into the inserting slot 122. The latching members 144 are inserted into the corresponding sliding groove 281. The main body 14 is pressed down by the user. Each latching protrusion 148 is crushed as it slides against the guiding surface 285 to deform the extending portion 146, until the latching protrusion 148 clicks home in the opening 286. The extending portion 146 unbends, and thereby the latching protrusion 148 is latched into the receiving portion 282. In this way, the first connector 10 is securely connected to the second connector 20. The electrical terminals 262 are, by virtue of the design, electrically coupled to the electrical terminals 124.

In separating the first connector 10 from the second connector 20, the main body 14 is pulled out from the second connector 20. The latching protrusion 148 of each latching member 144 is slidably abuts against the corresponding guiding portion 287, to deform the extending portion 146, until the latching protrusion 148 has been disengaged from the corresponding receiving portion 282. In this way, the first connector 10 may be easily separated from the second connector 20.

It is to be understood, however, that even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A connector assembly, comprising:
a first connector comprising an insulated main body, a latching member extending out from the main body, the latching member comprising a resilient extending portion extending from an outer surface of the main body, and a latching protrusion extending out from the extending portion; and
a second connector comprising an insulated base, a connecting member extending out from an outer surface of the base, the connecting member comprising a receiving portion for latching the latching protrusion.

2. The connector assembly of claim 1, wherein the first connector further comprises an inserting portion extending out from an end of the main body, the latching member is formed on a side surface of the main body and adjacent to the inserting portion, the base defines a receiving slot for receiving the inserting portion, the connecting member is formed on a sidewall of the base.

3. The connector assembly of claim 2, wherein a plurality of first electrical terminals is formed from the inserting portion, and a plurality of second electrical terminals is formed in the receiving slot, the first electrical terminals are electrically coupled to the second electrical terminals in response to the inserting portion being received in the receiving slot.

4. The connector assembly of claim 3, wherein the inserting portion defines an inserting slot extending through an end surface of the inserting portion opposite to the main body, the first electrical terminals are arranged on a sidewall of the inserting slot, a tongue extends from a bottom of the receiving slot to be inserted into the inserting slot, the second electrical terminals are arranged on a side surface of the tongue.

5. The connector assembly of claim 2, wherein the latching protrusion is semicircular, the receiving portion is semi-annular and defines an opening through which the latching protrusion enters the receiving portion.

6. The connector assembly of claim 4, wherein the connecting member further comprises a guiding portion extending up from a top of the receiving portion, an upper portion of the guiding portion forms a guiding surface against which the latching member slidably abuts to enter the receiving portion.

7. The connector assembly of claim 5, wherein a junction of the receiving portion and the guiding portion forms an arc-shaped guiding portion.

8. An assembly, comprising:
a motherboard;
a first connector fixed on and electrically connected to the motherboard, the first connector comprising an insulated base, a connecting member extending from a sidewall of the base perpendicular to the motherboard;
a hard disk drive;
a second connector comprising an insulated main body, a wire extending from a first end of the main body and electrically connected to the hard disk drive, a latching member extending from a side surface of the main body at a second end of the main body, to be detachably latched to the connecting member in response to the second connector being engaged with the first connector.

9. The assembly of claim 8, wherein the first connector is a female connector, and the second connector is a male connector, the first connector defines a receiving slot extending through a top of the base opposite to the motherboard, a tongue extends from a bottom wall of the receiving slot, the second connector further comprises an inserting portion extending from the second end of the main body to detachably engage in the receiving slot, the inserting portion defines an inserting slot extending through an end surface of the inserting portion opposite to the main body to receive the tongue.

10. The assembly of claim 9, wherein a plurality of first electrical terminals is formed on a side surface of the tongue, a plurality of second electrical terminals is formed on a sidewall bounding the inserting slot, to be electrically coupled to the first electrical terminals in response to the tongue being received in the inserting slot.

11. The assembly of claim 10, wherein the latching member comprises a resilient extending portion extending from the main body, and a latching protrusion protruding in a substantially perpendicular manner from the extending portion, the connecting member comprises an arc-shaped receiving portion and a guiding portion extending up from a top of the receiving portion, the latching protrusion is operable to slidably abuts against the guiding portion to deform the extending portion, until the latching protrusion engages in the receiving portion.

12. A connector assembly, comprising:
a first connector comprising an insulated main body, a latching member extending out from the main body, the latching member comprising a resilient extending portion extending from an outer surface of the main body, and a latching protrusion extending out from the extending portion; and
a second connector to be connected to the first connector, and comprising an insulated base, and a connecting member extending out from an outer surface of the base, the connecting member defining sliding groove and a receiving portion communicating with the sliding groove for latching the latching protrusion;
wherein when the first and second connectors are being connected, the latching member slides through the sliding groove, such that the latching protrusion is latched in the receiving portion and the resilient extending portion is received in the sliding groove.

13. The connector assembly of claim 12, wherein the first connector is a female connector, and the second connector is a male connector, the first connector defines a receiving slot extending through a top of the base opposite to the motherboard, a tongue extends from a bottom wall of the receiving slot, the second connector further comprises an inserting portion extending from the second end of the main body to detachably engage in the receiving slot, the inserting portion defines an inserting slot extending through an end surface of the inserting portion opposite to the main body to receive the tongue.

14. The connector assembly of claim 13, wherein a plurality of first electrical terminals is formed on a side surface of the tongue, a plurality of second electrical terminals is formed on a sidewall bounding the inserting slot, to be electrically coupled to the first electrical terminals in response to the tongue being received in the inserting slot.

15. The connector assembly of claim 12, wherein the latching protrusion is semicircular, the receiving portion is semi-annular and defines an opening through which the latching protrusion enters the receiving portion.
